(19) United States
(12) Patent Application Publication
(10) Pub. No.: US 2011/0314713 A1
(43) Pub. Date: Dec. 29, 2011

(54) TWO-PIECE PLACARD HOLDER

(76) Inventor: John Massaad, Broadview Hts., OH (US)

(21) Appl. No.: 12/825,181

(22) Filed: Jun. 28, 2010

(51) Int. Cl. G09F 21/04

(52) U.S. Cl. 40/593

(57) ABSTRACT

A two-piece placard holder having a mounting element for hanging from a post of a rearview mirror and a display frame for holding the placard. The display frame and mounting element are magnetically attached to one another to allow for easy assembly of the display frame to the mounting element (for hanging the placard, such as while parked) and easy dismounting of the display frame (and placard disposed therein) from the mounting element (for stowing the placard, such as while driving).

### TECHNICAL FIELD OF THE INVENTION

The present invention relates to placard holders for use in vehicles to display a placard in a windshield; and, more particularly, for holders which may releasably hold the placard, and which may enable easy hanging and removal of the placard from a mounting post of a vehicle component such as a rearview mirror, according to the desire of the user.

### BACKGROUND OF THE INVENTION

Currently, many informational placards are required to be displayed and easily viewed through the windshield of parked vehicles for various reasons. Some placards, such as handicapped parking permits, are required by law to be displayed in a visible and easy way to identify the vehicle as being legally parked in its designated space. Other placards, such as media/press and delivery, are used to identify the purpose of a parked vehicle, and some other placards, such as in car shows and car lots, are used to display features of a parked vehicle.

A typical placard may be a somewhat rigid, typically plastic card, measuring approximately 2 to 4 inches wide, and 3 to 9 inches long, and having a hook-type cutout near a top edge thereof allowing the placard to be hung on (from) a post, typically a substantially horizontally-extending mounting post of a vehicle component such as a front windshield-mounted rearview mirror, or a mounting post for a sun visor associated with the front windshield of the vehicle.

In such cases, these placards are temporarily displayed, and since most of them are hung on the post of the rearview mirror, they are required by law to be removed while the vehicle is in operation due to the danger associated with blocking the driver's line of sight. Since most of these placards are made from thin, rather fragile materials, displaying and removing them frequently will cause damage to them, especially under extremes of hot and cold that can be present throughout the seasons of the year. Also, blindly hanging and removing a placard to and from the post of the rearview mirror causes the hook to break. Furthermore, not all vehicles' rearview mirror posts have the same diameter; some may be as small as ½″ diameter, and some are over 1.0″ diameter, making it hard for a standard size hook typically used for placards to fit all.

Examples of informational placards include: handicapped or parking passes; identifications of a parked vehicle of a member of the media/press, or of a delivery service; placards that display information about a vehicle at a car show or dealership.

Some placard holders (placard holding devices) of the prior art comprise a typically transparent display frame into which the placard may easily be inserted. Then, the holder is attached somehow, for example, to the mounting post of the rearview mirror or to the visor of the vehicle. Since the means of attachment is typically an integral part of these placard holders, they may be referred to as a “one-piece placard holder”. Various one-piece placard holders are described in the prior art, such as the following.

U.S. Pat. No. 7,150,120 (Naymik), incorporated by reference herein, discloses a vehicle permit holder. A vehicle permit display device includes a substantially hollow, wide profile envelope formed of a transparent material. The envelope includes an opening on a side edge thereof for receiving a vehicle permit. A hook portion of the permit holder is an extension of an upper edge of the envelope for securing to a vehicle rearview mirror mounting post. Alternatively, the device may be fastened to a vehicle window using suction cups or other similar means.

U.S. Pat. No. 7,373,745 (Massaad), incorporated by reference herein, discloses a visor mounted placard holder. A placard holder device that removably holds for display an informational placard that can be viewed through the windshield of a parked vehicle, and which enables simple and quick manual repositioning into a stored position that does not obstruct the line of sight through the windshield. Only a single action step is needed to make the placard visible or invisible. The device features: a frame that removably holds the placard for display, a mounting body having a hinged connection to the frame, a clasp distal to the hinged connection for releasably clasping the frame to the body, and a clip for removable attachment to a visor of the vehicle. Examples of informational placards include: handicapped or parking passes; identifications of a parked vehicle of a member of the media/press, or of a delivery service; placards that display information about a vehicle at a car show or dealership.

It is an object of the present invention to provide an inexpensive, easy to use placard display device (placard holder) for vehicles. The device should be easily moved from one vehicle to another, or from the rearview mirror mounting post to a visor mounting post. Ease of use should involve only one action step to either display the placard or to remove it from view. A display frame portion of the placard holder should enable easy insertion/removal of a variety of placard sizes and shapes. The placard should be removably held in a transparent frame that will help prevent placard deterioration and that will display (allow viewing of, through the windshield) the informational graphics on at least one face of the placard.

### BRIEF SUMMARY OF THE INVENTION

According to an embodiment of the invention, a two-piece placard holder for mounting inside of a windshield of a vehicle comprises (i) a mounting element (a first piece) for suspending the placard holder from a mounting post (such as the rearview mirror mounting post or a visor mounting post), (ii) a display frame (a second piece) that removably holds the placard (such as by inserting the placard into the display frame), and (iii) means for releasably attaching the display frame to the mounting element.

In an embodiment exemplifying the means for releasably attaching, a magnet (magnetic element) is provided on one or the other of the mounting element or the display frame, and a ferrous element (such as a steel strip or metal plate) is provided on the other of the mounting element or the display frame to allow easy “assembly” and “disassembly” of the mounting element and the display frame elements of the two-piece placard holder. The mounting element is small enough to remain attached to (e.g., hooked on) the mounting post such that it does not obstruct a driver's view.

In this manner, the display frame of the placard holder is easily detached from, or attached to, the mounting element. Thus the placard is easily removed or hung from the mounting post when it is held by the inventive two-piece placard holder—advantageously much more easily and faster than doing so with just the placard alone.

Further according to the invention, the display frame comprises a planar front panel (“front”), a planar back panel (“back”), and a spring biasing the front against the back for removably holding the placard between the front and the back; wherein the front is transparent such that information on the placard is displayed through the front. Even further, the display frame is a single sheet (or length) of material that is folded over on itself such that one folded edge is the bias spring of the display frame.

A first one of the front and back panels may be elongated to extend beyond an edge of the second one of the front and back panels and the edge of the second panel is curved away from the first panel for easing insertion of the placard into the display frame.

Further according to the invention, the display frame front is transparent for displaying information on a placard that is removably held in the display frame.

Other objects, features and advantages of the invention will become apparent in light of the following description thereof.

### BRIEF DESCRIPTION OF THE DRAWINGS

Reference will be made in detail to preferred embodiments of the invention, examples of which are illustrated in the accompanying drawing figures. The figures are intended to be illustrative, not limiting. Although the invention is generally described in the context of these preferred embodiments, it should be understood that it is not intended to limit the spirit and scope of the invention to these particular embodiments.

Certain elements in selected ones of the drawings may be illustrated not-to-scale, for illustrative clarity. The cross-sectional views, if any, presented herein may be in the form of “slices”, or “near-sighted” cross-sectional views, omitting certain background lines which would otherwise be visible in a true cross-sectional view, for illustrative clarity.

Elements of the figures can be numbered such that similar (including identical) elements may be referred to with similar numbers in a single drawing. For example, each of a plurality of elements collectively referred to as 199 may be referred to individually as 199a, 199b, 199c, etc. Or, related but modified elements may have the same number but are distinguished by primes. For example, 109, 109′, and 109″ are three different elements which are similar or related in some way, but have significant modifications. Such relationships, if any, between similar elements in the same or different figures will become apparent throughout the specification, including, if applicable, in the claims and abstract.

The structure, operation, and advantages of the present preferred embodiment of the invention will become further apparent upon consideration of the following description taken in conjunction with the accompanying drawings, wherein:

FIG. 1 is an exploded perspective view of a two-piece placard holder showing a mounting element, a display frame, and means for releasably attaching the display frame to the mounting element for hanging a placard from a mounting post of an automotive component such as a rearview mirror, all according to an embodiment of the invention.

FIG. 2 is an exploded perspective view of a two-piece placard holder showing the placard being inserted in the display frame, all according to an embodiment of the invention.

FIG. 3 is a perspective view of the two-piece placard holder of FIG. 2 showing the mounting element and display frame assembled together, with the placard inserted between front and back panels of the display frame, all according to an embodiment of the invention.

FIG. 4 is a perspective view of the assembled two-piece placard holder of FIG. 3 showing it removably mounted on a mounting post of a rearview mirror for displaying the placard in a front windshield of a vehicle, all according to an embodiment of the invention.

### DETAILED DESCRIPTION OF THE INVENTION

Referring now to the drawings, the Figures (Figs.) show various views of some embodiments of the two-piece placard holder of the present invention, and some examples of its use. Some dimensions may be presented to provide context and a sense of relative size, but should not be construed as limiting the invention to a particular size.

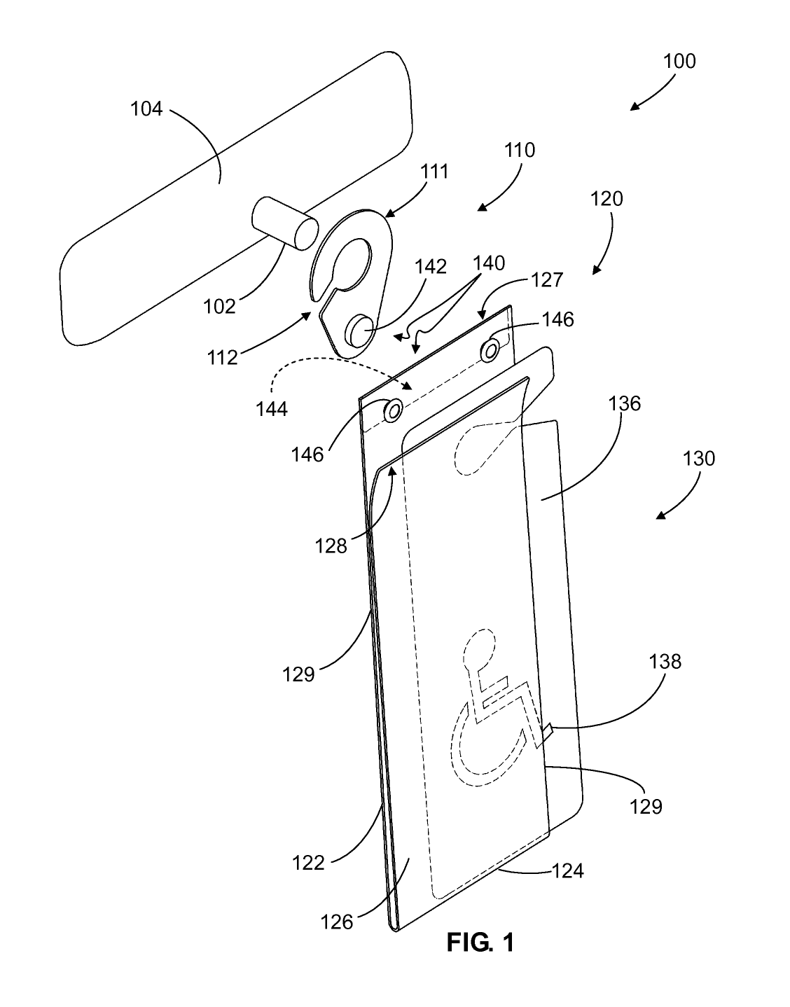

FIG. 1 shows a two-piece placard holder 100 which comprises a mounting element 110 and a display frame 120. The placard holder 100 is generally for holding (or retaining) a placard 130, and for suspending (or hanging) the placard from a mounting post 102 (or other suitable element) of an automotive component 104 such as a rearview mirror 104 mounted inside (or extending from) the front windshield (or windscreen) of a vehicle such as a passenger car. The placard 130 may measure, for example, approximately 2 to 4 inches by 3 to 9 inches for accommodating dimensions of informational placards commonly displayed in vehicles.

Examples of informational placards include: handicapped or parking passes; identifications of a parked vehicle of a member of the media/press, or of a delivery service; and placards that display information about a vehicle at a car show or dealership.

The invention is not limited to a specific type of vehicle, or to a specific type of automotive component. For example, the automotive component 104 shown is a rearview mirror. Another automotive component 104 having a mounting post 102 from which the placard holder 100 may be suspended is a front window visor.

In general, the placard holder 100 is intended in use to suspend a placard 130 adjacent the front windshield of the vehicle so that the placard 130 is visible, i.e., displayed, through the windshield. An object of the invention is to provide means for easily hanging (mounting) and easily removing (dismounting) the placard 130 from display in the vehicle. As will be seen, the placard 130 may be removed by separating (releasably detaching) the display frame 120 holding the placard 130 from the mounting element 110 that is mounted on the automotive component 104. In use, the mounting element 110 will be left hanging from (mounted on) the automotive component 104, therefore the means for mounting the mounting element 110 on the automotive component 104 encompass a very wide range of methods and devices—both permanent (e.g., affixing with glue, screws, and the like) and removable (e.g., a releasable attachment).

In a preferred embodiment, the mounting element 110 is removably mounted on the automotive component 104 because many applications of a placard holder are either temporary (e.g., handicapped while recovering from injury) or need to be easily moved from one vehicle to another (e.g., a press pass). Thus the mounting element 110 may be a generally flat, planar element shaped like a hook 111 measuring approximately 2 inches×2 inches, made of a suitably rigid material such as 1/16 inch thick plastic material. As illustrated, the mounting element 110 has a notch 112 extending into one side edge thereof, wherein the notch 112 is suitably sized and shaped to allow the mounting post 102 to pass through the notch 112 to be retained in the hook 111 of the mounting element 110, and similarly to be easily removed from the mounting post 102. The notch 112 is suitably slightly smaller than a diameter of the mounting post 102, and the hook 111 has an appropriate hook shape (or profile) such that the hook 111 with notch 112 will retain the mounting element 110 to stay suspended from the mounting post 102 until advertently removed therefrom. Thus the hook 111 and notch 112 of the mounting element 110 are suitably sized and shaped to make the mounting element 110 removably mountable on the mounting post 102 of the automotive component 104.

The display frame 120 may comprise a first (or front) portion (or panel) 126 joined to a second (or back) portion (or panel) 122.

The front 126 and back 122 panels (or simply, “front” and “back”) are generally planar, may be generally rectangular, and may be generally about the same size as one another, and each should be at least as large as the placard 130 intended to be retained therein.

The front and back panels (126 and 122, respectively) may be held together in a manner that the placard 130 can easily be inserted and securely retained between the front 126 and back 122. In “normal” use, it is generally intended that the placard 130 remain retained in the display frame 120, but it may of course be removed therefrom, so as to insert another placard 130 into the display frame 120.

The front panel 126 may be integrally formed with (or joined to) the back panel 122 by a spring biased edge 124 (i.e., “a spring 124 biasing the front 126 against the back 122”). For example, the display frame 120 may be made of plastic, for example transparent (clear) thermoformed acrylic sheet material that is folded over on itself along one edge 124. If suitably formed, there will be enough space allowed between the front 126 and the back 122 to allow insertion therein of a typical range of placard thicknesses. For retaining the placard 130 between the front 126 and the back 122, the plastic material should have enough flexibility to provide a spring bias at the folded edge 124. Although preferably a fold at the bottom edge as shown, the spring bias edge 124 could be, for example, along part or all of any of the display frame's edges, or for example, it could take the form of a separate (e.g., metal) spring 124 (rather than a fold) that provides the desired functionality of biasing the front 126 against the back 122.

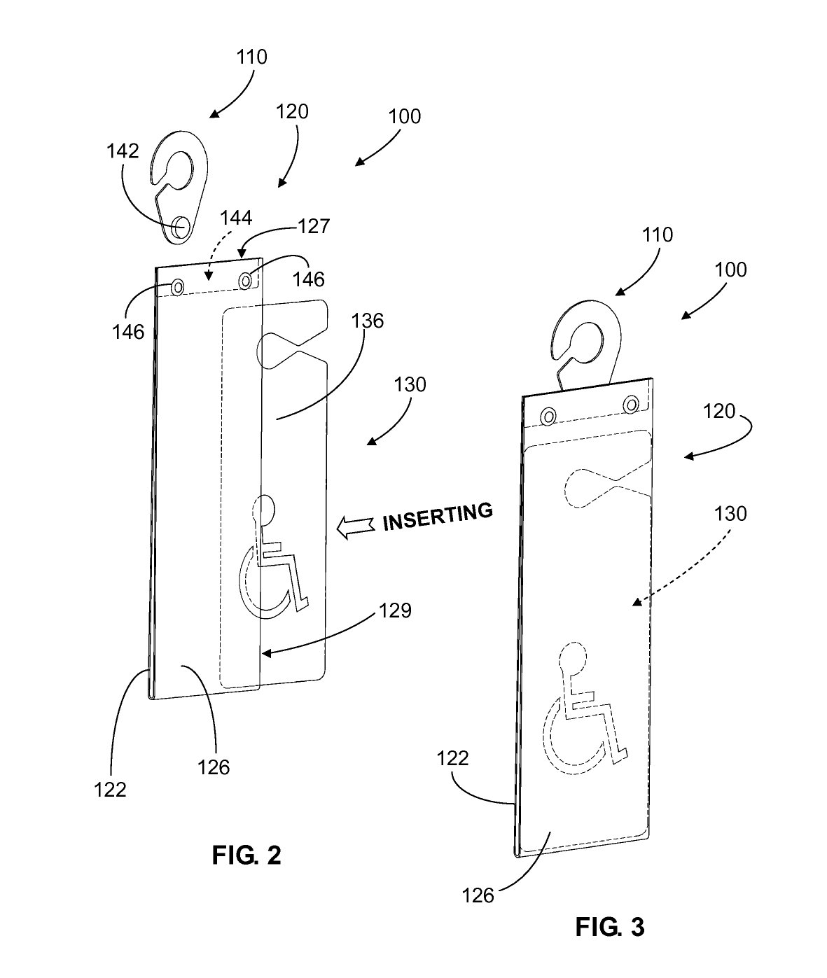

In one embodiment, illustrated by FIG. 1, an open edge (e.g., edges 129) of the display frame 120, for example the front's top edge 127 as illustrated, can have an optional insertion lip 128 that diverges outward (curves away from) the back 122 for easing (facilitating) insertion of the placard 130 between the front 126 and the back 122, or the top edges of the front 126 and the back 122 may be held together by mechanical fasteners 146, as shown in FIG. 2. Obvious variations of these embodiments include the insertion lip 128 being formed in either or both of the front panel 126 and the back panel 122 along any open edge 129 of the display frame 120.

Given the teachings of the present disclosure it will become apparent that functional equivalents of the inventive features described herein can be implemented in many different shapes and forms and materials, all of which are intended to be within the scope of the present invention.

At least the front 126 and preferably also the back 122 is transparent such that information 138 (graphics, possibly including text) on at least a front side 136 of the placard 130 will be visible when the placard 130 is placed in the display frame 120, i.e., pushed through an open edge 129 between the front 126 and the back 122 as illustrated in FIGS. 2 and 3.

It is desirable to have a transparent back 122 because that allows more flexibility in the use of the holder 100. For example, a placard 130 having display information on both sides could be simultaneously viewed from both the front and the back of a vehicle. Of course the “transparent” functionality of the front 126 and/or the back 122 can also be provided, for example, by using an opaque picture frame-like rectangle with a cutout open center (e.g., sheet metal with a center portion cut out to be an open window).

Means 140 are provided for releasably attaching the display frame 120 (and placard 130 retained therein) to the mounting element 110. The general object of said means 140 for releasably attaching is to facilitate easily assembling (attaching) the display frame 120 to the mounting element 110 and conversely easily disassembling (detaching) the display frame 120 from the mounting element 110. An exemplary means for releasable attaching will now be described.

A magnet (magnetic element) 142 may be provided on the mounting element 110, and a ferrous element (such as a steel strip or metal plate) 144 may be provided on the display frame 120 to allow easy “assembly” and “disassembly” of the mounting element 110 and the display frame 120 (or “attaching” the display frame 120 to the mounting element 110 and “detaching” the display frame 120 from the mounting element 110.)

The magnet (magnetic element) 142 may be provided at a bottom portion of the mounting element 110, below the notch 112, and stays with the mounting element 110. The magnet 142 may, for example, be glued to the mounting element 110.

The steel strip (or metal plate) ferrous element 144 may extend across a top edge 129 of the back panel 122, and stays with the display frame 120. The steel strip 144 may, for example, be held (secured) to a top edge 129 of the back panel 122 by one or more mechanical fasteners 146 such as, for example, eyelets or rivets. As shown in FIGS. 2-4) the mechanical fastener(s) 146 may also secure together the top edges 127 of both the front 126 and back 122, thereby holding the top of the display frame 120 together independently of a spring bias 124.

In the main, an embodiment of the invention comprising the magnet 142 integral with the mounting element 110, and the ferrous element 144 integral with the display frame 120 is disclosed, it being understood that other generally equivalent means for releasable attachment are considered to be within the scope of the invention as claimed. (For example, hook and loop fabric pieces could be used). Given the present disclosure, other examples will no doubt occur to one of ordinary skill in the related art.)

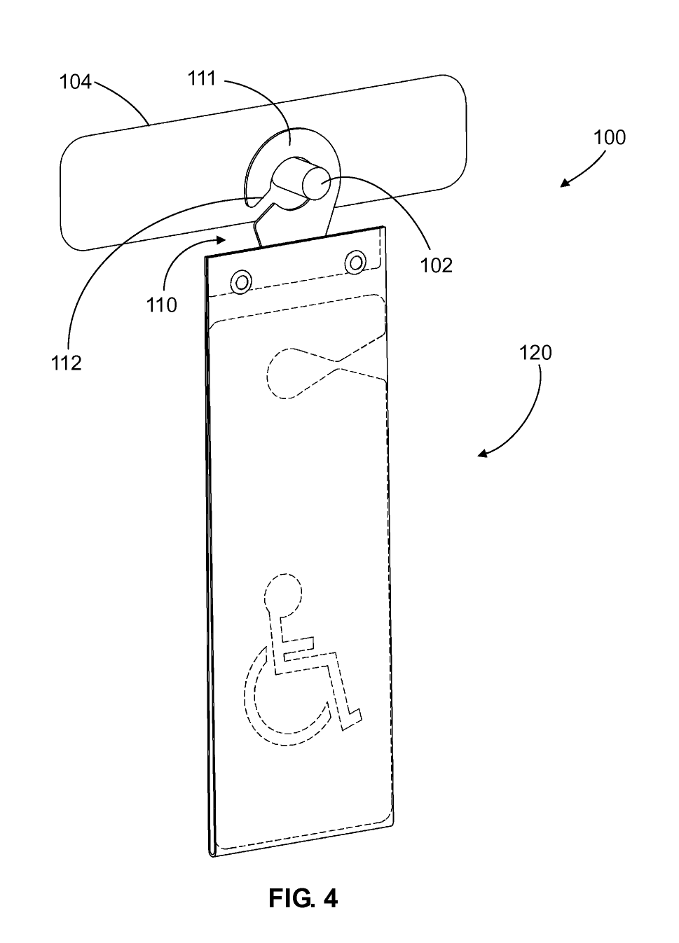

FIG. 3 shows the mounting element 110 and display frame 120 assembled together, with the placard 130 inserted between the front panel 126 and the back panel 122 of the display frame 120, such as in preparation for using the hook 111 and notch 112 as a means for mounting the mounting element 110 on the automotive component 104 when initially hanging the two-part placard holder 100 from a mounting post 102 of a rearview mirror 104 as shown in FIG. 4.

For removing (or stowing, or dismounting, or detaching) the placard 130 (such as when driving, rather than while parked), the display frame 120 may be separated from the mounting element 110 in a simple, easy one-step process such as by grasping the display frame 120 with one hand and pulling it down, thereby overcoming the magnetic attraction between the magnet 142 and the steel strip 144. The display frame 120 with the placard 130 contained therein is temporarily stowed out of the line of sight of the driver, and the mounting element 110 remains mounted on the automotive component 104, but due to its intentionally short height, it is substantially out of the line of sight of the driver. Furthermore, since the typically flimsy placard 130 is stored and handled while contained in a relatively strong and weighty display frame 120, the placard 130 is protected from damage in handling and is less likely to be lost (e.g., blowing away if left on a seat, e.g., falling into a narrow crevice where it is hard to find, e.g., buried in papers while stored in a glove box).

For releasably reinstalling (or hanging, or mounting, or reattaching) the placard 130 (such as when parked, rather than while driving), the display frame 120 may be joined (or reattached) to the mounting element 110 in a simple, easy one-step process by presenting the display frame 120 to the mounting element 110 and the magnetic attraction will capture the display frame 120 to the mounting element 110.

Generally, the mounting element 110 stays on (is mounted to) the post 102, and the placard 130 stays in (is retained in) the display frame 120. The magnetic “attachment” of the display frame 120 to the mounting element 110 facilitates this easy mounting (for displaying) and dismounting (for stowing) of the display frame 120 within which the placard 130 is retained.

In this manner, a technique has been provided for easily and releasably suspending (or hanging) a placard from a mounting post of an automotive component (such as the rearview mirror mounting post or a visor mounting post). When suspended from the mounting post, the placard is visible through the windshield of the vehicle. When the placard is removed in a simple one-step process, the technique does not leave objects on the mounting post that will significantly block the driver's line of sight. Furthermore, the technique protects the placard from damage, and helps prevent loss of it.

Although the invention has been illustrated and described in detail in the drawings and foregoing description, the same is to be considered as illustrative and not restrictive in character-it being understood that only preferred embodiments have been shown and described, and that all changes and modifications that come within the spirit of the invention are desired to be protected. Undoubtedly, many other “variations” on the “themes” set forth hereinabove will occur to one having ordinary skill in the art to which the present invention most nearly pertains, and such variations are intended to be within the scope of the invention, as disclosed herein.

What is claimed is:

1. A placard holder for hanging a placard in a vehicle comprising:
a mounting element for hanging from a mounting post of an automotive component;
a display frame for holding the placard; and
means for releasably attaching the display frame to the mounting element.

2. The placard holder of claim 1, wherein the automotive component is a rearview mirror mounted inside a front windshield of the vehicle.

3. The placard holder of claim 1, wherein the placard is an informational placard selected from the group consisting of handicapped or parking passes; identifications of a parked vehicle of a member of the media/press, or of a delivery service; and placards that display information about a vehicle at a car show or dealership.

4. The placard holder of claim 1, wherein the mounting element comprises:
a flat planar element shaped like a hook and having a notch extending into one side edge thereof, the hook and the notch being suitably sized and shaped to enable the mounting element to be easily hooked onto and then retained on the mounting post, or to be easily removed from the mounting post.

5. The placard holder of claim 1, wherein at least one of the front and back are transparent.

6. The placard holder of claim 1, wherein the display frame comprises:
a planar front, a planar back, and a spring biasing the front against the back for removably holding the placard between the front and the back.

7. The placard holder of claim 6, wherein the display frame further comprises:
a single sheet of material that is folded over on itself such that one folded edge constitutes the spring biasing the front against the back.

8. The placard holder of claim 7, wherein the material comprises transparent plastic sheet material.

9. The placard holder of claim 6, wherein:
an edge of a one of the front or back is curved away from the other one of the front or back;
thereby easing insertion of the placard into the display frame.

10. The placard holder of claim 1, wherein the display frame comprises:
a single sheet of transparent plastic sheet material that is folded over on itself to form a front and a back that are springingly held together by a folded edge.

11. The placard holder of claim 1, wherein the means for releasably attaching comprises:
a magnet on a one of the mounting element or display frame and a ferrous element on the other one of the mounting element or display frame.

12. The placard holder of claim 11, wherein:
the magnet is disposed on the mounting element; and
the ferrous element comprises a steel strip extending across a top edge of the back of the display frame.

13. The placard holder of claim 12, wherein the steel strip is secured to the top edge by a mechanical fastener that also holds the front and back together.

14. A method of mounting and dismounting a placard from a automotive component such that when mounted the placard is visible through a windshield of a vehicle, the method comprising the steps of:
providing a mounting element for hanging from a mounting post of the automotive component;
providing a display frame for retaining the placard; and
providing means for releasably attaching the display frame to the mounting element.

15. The method of claim 14, wherein:
the automotive component is a rearview mirror mounted inside a front windshield of the vehicle; and
the means for releasably attaching comprises a magnet provided on a one of the display frame or the mounting element, and a ferrous element provided on the other one of the display frame or the mounting element.

16. The method of claim 14, wherein the display frame comprises:
a planar front, a planar back, and a spring biasing the front against the back for removably holding the placard between the front and the back.

17. The method of claim 14, wherein the display frame comprises a single sheet of transparent plastic material that is folded over on itself.

18. A method of releasably mounting a placard to an automotive component such that when mounted the placard is visible through a windshield of a vehicle, the method comprising the steps of:
mounting a mounting element on the automotive component;
retaining the placard in a display frame; and
magnetically attaching the display frame to the mounting element.

19. The method of claim 18, wherein the automotive component is a rearview mirror mounted inside a front windshield of the vehicle.

20. The method of claim 18, wherein the display frame comprises:
a planar front, a planar back, and a spring biasing the front against the back for removably holding the placard between the front and the back.
